(19) United States
(12) Patent Application Publication
(10) Pub. No.: US 2016/0356443 A1
(43) Pub. Date: Dec. 8, 2016

(54) SIMPLY DETACHABLE INTEGRATED LED FIXTURE

(71) Applicant: OZG Powersports, Inc., Santee, CA (US)

(72) Inventor: Gong Beiwen, Zhongshan City (CN)

(73) Assignee: OZG Powersports, Inc., Santee, CA (US)

(21) Appl. No.: 14/728,416

(22) Filed: Jun. 2, 2015

(51) Int. Cl. F21S 8/10; F21V 31/00; F21V 29/50

(52) U.S. Cl. CPC F21S 48/00; F21V 29/50; F21V 31/005; F21Y 2101/02

(57) ABSTRACT

A simply detachable integrated LED fixture includes die-cast aluminum housing structure for heat-dissipation which locates at the rear of the structure. Brackets are on each end of the housing structure. Brackets are firmly connected with end cups and waterproof gaskets. Some LED module kits are firmly jointed with the die-casting aluminum housing, from the inside to the outside of the LED module kits, there are aluminum PCB plate with LED bulbs, optic lens, waterproof rubber ring, PC cover and aluminum frame. Optic lens are screwed with aluminum PCB plate, on which LED bulbs are mounted, aluminum frame is screwed in the front side of the die-casting aluminum housing structure. The Utility Model can be easily installed and disassembled, which saves the maintenance cost.

### FIELD

The invention relates to light bars for vehicles.

### BACKGROUND

LED light bars are useful for vehicles for illuminating a work site or a trail. Such bars need to be durable and water-resistant, but also must remove heat from the LED.

### SUMMARY

A simply detachable integrated LED fixture includes die-cast aluminum housing structure for heat-dissipation which locates at the rear of the structure. Brackets are on each end of the housing structure. Brackets are firmly connected with end cups and waterproof gaskets. Some LED module kits are firmly jointed with the die-casting aluminum housing, from the inside to the outside of the LED module kits, there are aluminum PCB plate with LED bulbs, optic lens, waterproof rubber ring, PC cover and aluminum frame. Optic lens are screwed with aluminum PCB plate, on which LED bulbs are mounted, aluminum frame is screwed in the front side of the die-casting aluminum housing structure. The Utility Model can be easily installed and disassembled, which saves the maintenance cost.

### BRIEF DESCRIPTION OF FIGURES

FIG. 1 shows a vehicle-mounted light, according to an embodiment of the invention.

### DETAILED DESCRIPTION

A simply detachable integrated LED fixture has die-cast aluminum housing structure 1 for heat-dissipation having a heat-dissipation area 11. A bracket 2 is mounted on each end of the housing structure 1. End cup 3 is affixed to the structure 1 and sealed with a waterproof gasket 4 (not shown). Brackets 2 are firmly connected to end cups 3 and waterproof gaskets. Some LED module kits A are firmly jointed with the die-casting aluminum housing, from the inside to the outside of the LED module kits, there are aluminum PCB plate with LED bulbs 5, optic lens 6, sealed using a waterproof rubber gasket 7 (not shown), PC cover 8 (not shown) and aluminum frame 9. Optic lenses 6 are screwed with aluminum PCB plate mounted by LED bulbs 5, and aluminum frame 9 is screwed in the front side of the die-casting aluminum housing structure 1.

The LED module kits A are connected by the impact plate 10 and the waterproof rubber rings behind (not shown), and then assembled with the die-casting aluminum housing structure 1.

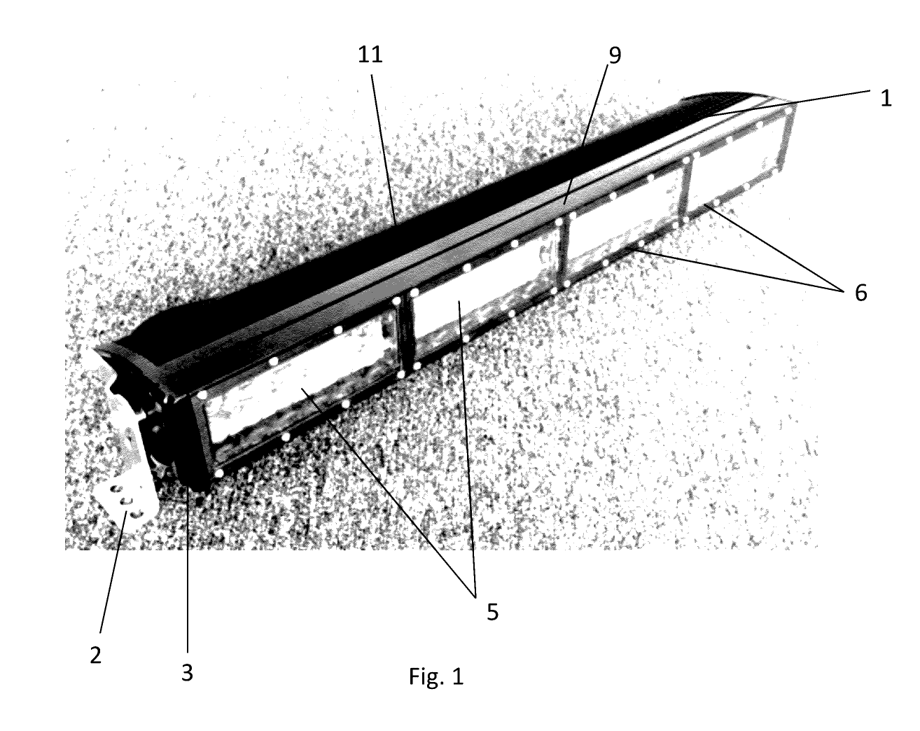

According to FIG. 1, the LED module kits are connected the die-casting aluminum housing bar through the impact plate (10) and waterproof rubber rings(12). LED module kits stated in the Utility Model can be installed and disassembled independently, therefore, when some parts or LED bulbs malfunction, they can be easily fixed without detaching the entire fixture or changing the whole PCB plate, which greatly lowers the cost of maintenance.

1. A light bar for a vehicle comprising:
a. an aluminum housing structure having a heat-dissipation area;
b. an end cup sealingly mounted to each end comprising a mounting bracket;
c. one or more LED module mounted within the structure
d. optic lenses covering each LED module; and
e. an aluminum frame sealingly retaining the lenses and modules within the structure.
